(19) United States
(12) Patent Application Publication
(10) Pub. No.: US 2012/0123919 A1
(43) Pub. Date: May 17, 2012

(54) Method And System For Billing In A Communication Network

(75) Inventors: Xiang Yang Li, Beijing (CN); Yigang Cai, Napervlle, IL (US)

(73) Assignee: Alcatel-Lucent USA Inc., Murray Hill, NJ (US)

(21) Appl. No.: 12/947,928

(22) Filed: Nov. 17, 2010

(51) Int. Cl. G06Q 30/00

(52) U.S. Cl. 705/34; 705/30

(57) ABSTRACT

A method and system for charging for services delivered by a communication network. After receiving a request for service in the network, usually initialed by a UE, an online charging system retrieves subscriber information, typically including subscriber account balance information, and compares the retrieved subscriber information with reverse rating policy rules to determine if reverse rating is to be performed prior to responding to the request for service. If so, the online charging system is directed to perform the reverse rating. If not, the service is provided without performing reverse rating. A dummy quota may be generated if reverse rating is not performed. In one embodiment, reverse rating may be performed after a service session was allowed to commence without reverse-rating if the session consumes an amount of service reaching a threshold determined after the operation of determining whether reverse rating is to be performed.

### TECHNICAL FIELD

The present invention relates generally to the field of communication networks, and, more particularly, to a method and billing system used in charging for communication services, which, in implementation, is expected to lower the cost of implementing a communication network by reducing the number of hardware components required to perform certain rating calculations.

### BACKGROUND

The following abbreviations are herewith defined, at least some of which are referred to within the following description of the state-of-the-art and the present invention.
3GPP 3^{rd} Generation Partnership Project
AAA Authentication, Authorization, and Accounting
CTF Charging Trigger Function
IETF Internet Engineering Task Force
LTE Long Term Evolution
OCF Online Charging Function
OCS Online Charging System
PCC Policy and Charging Control
PCEF Policy and Charging Enforcement Function
PCRF Policy and Charging Rules Function
RFC Request for Comments (an IETF term)
VoIP Voice over Internet Protocol

Communication services have evolved a great deal from their origins in the 19^{th} century, where a very few network owners and operators provided basic telephone service, often for a fixed monthly fee. Modern communication systems, in contrast, involve a great many additional components, and many times the different components used to make even a single call are owned or operated by different entities. Basic voice service is still available, of course, using either landline or wireless access, but also available are services such as short messaging, push-to-talk, games and gaming, data transmission, and access to the Internet and World Wide Web.

Payment options have also evolved. While some communication services are offered free-of-charge to the consumer, such as those paid for by advertisers, many others take the form of a subscription service. A subscription service may be billed as a flat fee, for example, monthly or annually, or on the basis of how much a subscriber makes use of the service. Naturally, there can be combinations of these methods as well, for example a flat rate for use of the service up to a certain use threshold, with a use-base charge levied when the flat-rate use threshold has been reached.

Subscriber payment for services used may be made before or after the service is actually rendered. Again, there may be a hybrid of these options. A flat-rate payment may be expected monthly, for example, with additional use-based charges being included in the next flat-rate invoice. Collections can be a concern, of course, and most service providers do not want to be in the position of having to collect relatively-small amounts of money from each of perhaps many non-paying subscribers.

For this reason, payment in advance is preferred in many situations. A subscriber may actually pay a lump sum for charging against at a later time, or a payment may be collected just prior to making the service available, for example by credit card. As should be apparent, however, any advance payment will only cover a certain amount of later services. Service providers also wish to avoid the situation where a subscriber's pre-paid account may have a positive balance the beginning of a communication session, but a negative balance when the session has been completed.

Reverse rating addresses this concern. Reverse rating occurs when an online charging system (OCS) receives a charging request. The charging request provides the identity of the subscriber and the service requested, and may give additional details associated with the service request as well. The OCS then determines a unit quota—the amount of the service that the subscriber may use, for example a sixty—minute domestic voice call. The quota is typically based on the balance available in the subscriber's account. Here, the subscriber account balance will include both the amount of funds that have been pre-paid and the available credit line, if any, to which the subscriber is entitled.

The unit quota is calculated in terms of units of the requested service, but corresponds to an equivalent monetary amount. As part of the reverse rating process, this equivalent monetary amount is typically deducted or reserved from the subscriber's account balance. This prevents the subscriber from inadvertently or intentionally using too much of the service before normal rating is performed, and ending up with a significant negative account balance. Note that if the subscriber account balance is large relative to an anticipated service use, the unit quota may not be equivalent to the entire available balance.

Normal rating is typically performed at or after the conclusion of a communication session, and includes adjusting the amount deducted or reserved during the reverse rating process. That is, if the subscriber used more of the service than was represented by the reverse rating equivalent monetary amount, the difference is deducted from the subscriber account. Of course if the amount of the service actually used was less than the quota, the difference is credited to the subscriber account balance. Note here that precise accounting method used is not material to the invention. If a portion of the subscriber account balance was only reserved or put on hold, not actually deducted, then the reservation or hold is simply released prior to deducting in normal rating an amount equivalent to the actual services used.

Although the process of reverse rating followed by normal rating is important for protecting the financial interests of the service provider, and may help the subscriber avoid using more of the offered services than intended, it does consume a significant amount of processing time. The carrier, or other network operator, has no choice but to install as many components such as servers or other network elements to accommodate the expected processing demand, including the burden of performing the reverse rating process for subscribers.

Always needed, therefore, are ways to reduce the processing burden on the network associated with the expected demand generally, and with reverse rating in particular. If the anticipated demand can be reduced, then the amount of equipment that needs to be installed to perform the processes may be reduced as well. This will hopefully in turn reduce capital and operations costs for the operator.

Note that the techniques or schemes described herein as existing or possible are presented as background for the present invention, but no admission is made thereby that these techniques and schemes were heretofore commercialized or known to others besides the inventors.

### SUMMARY

The present invention is directed to an efficient method and system of billing, or charging, in a communication network, and is especially advantageous in networks where payment is obtained from subscribers in advance for some or all of the services available through the network. In one aspect, the present invention is a method for billing in a communication system, including the steps of receiving a service request associated with a UE device, retrieving subscriber information for the subscriber associated with the UE, comparing the subscriber information with a policy rules database, determining whether reverse rating is to be performed based on the comparison, and performing reverse rating if it is determined that reverse rating is to be performed. In various embodiments, the subscriber information may include, for example, the subscriber account balance, the subscribed tariff plans, the type of services subscribed, or the payment methods associated with the services or the subscriber. In other embodiments the subscriber information may comprise a combination of two or more of these factors.

If reverse rating is not to be performed, a dummy service unit quota may be assigned, and if the dummy quota is reached, another determination of whether reverse rating is to be performed may be executed. The method may also include separately determining whether the service request should be granted and send a message acknowledging the service request and indicating whether performance of the service is to be allowed. The method may also include the step of performing normal rating after all or some of the service has been performed.

In some embodiments, such as in environments operating according to a Diameter protocol, the method is performed in an OCS in communication with a charging client in a service element. In other embodiments, such as in an LTE network, the method is performed in a PCRF, which retrieves subscriber information from an OCS, and provides rules for monitoring the service provision to a PCEF.

In another aspect, the present invention is an online charging system for use with a communication system, including a memory device for storing subscriber information and reverse rating policy rules and a processor for executing software stored on the storage device for retrieving the stored subscriber information and policy rules, and determining whether reverse rating is to be performed with respect to the request for service based at least in part on comparing the policy rules with the retrieved subscriber information. The online charging system may also perform reverse rating if it is determined that reverse rating is to be performed, and perform normal rating upon completion of the service.

In yet another embodiment, the present invention is a charging system for use in an LTE communication network, including an OCS configured for maintaining information relating to subscribers comprising subscriber account balance information, a PCRF configured for determining whether reverse rating should be performed with regard to a request for service, wherein the determination is a function of subscriber information retrieved from the OCS by the PCRF, and a PCEF configured for receiving the request for service and communicating with the PCRF to initiate the determination and for enforcing rules provided to the PCEF by the PCRF relating to the performance of the service requested in the request for service.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selected components of a communication network that may be configured according to an embodiment of the present invention;

FIG. 2 is a flow diagram illustrating a method of billing according to an embodiment of the present invention;

FIG. 3 is a simplified block diagram illustrating selected components of an OCS according to an embodiment of the present invention;

FIG. 4 is a simplified schematic diagram illustrating selected components of an LTE network configured according to an embodiment of the present invention; and

FIGS. 5a through 5c are message flow diagrams illustrating operation of an LTE network according to an embodiment of the present invention.

### DETAILED DESCRIPTION

The present invention is directed to an efficient manner of billing, or charging, in a communication network, and is especially advantageous in networks where payment is obtained from subscribers in advance for some or all of the services available through the network. Note, however, that the invention may be useful with other billing schemes as well. Note also that it is not relevant which entity actually provides the services, only that at some time charging or accounting is used in connection with providing the service. Finally, note that as used herein, “service” includes both “events”, such as content downloading, and “sessions”, such as a VoIP telephone call.

FIG. 1 is a simplified schematic diagram illustrating selected components of a communication network that may be configured according to the present invention. In the embodiment of FIG. 1, UE device 101 may access services through the communication network by establishing communication with the RAN 105. The RAN 105 consists of the elements necessary for this communication, such as an antenna and base station (not separately depicted). Communications from UE 101 to and from, for example, a packet data network 115 via a gateway element 110.

Control signaling between the various network elements is used to establish a communication session for the UE and to perform related functions. For example, in the embodiment of FIG. 1 a service element 120 sends a request to AAA element 125 to determine whether UE should be permitted access to the network. Service element 120 is shown as a client that is part of gateway 110, though this configuration is not necessarily required. Also present is an OCS element 130 that performs rating for service requests made by UE 101 or some other requesting device, especially for services that have been prepaid or postpaid by a subscriber. OCS 130 may therefore perform a gate keeping function in the sense that if the subscriber's account balance is insufficient to cover the requested service, the service request may be denied.

As mentioned above, rating may include reverse rating and normal rating. Normal rating is performed after a service, or portion thereof, has been rendered (or at least after the amount of the service or service portion provided has been determined). Whatever the subscriber has paid, or in some cases also including whatever credit the service provider is willing to extend, is the subscriber account balance. Reverse rating occurs prior to the service being delivered, and involves reserving a portion or all of the subscriber account balance so that funds for the requested service cannot be accessed for the provision of a different service prior to normal rating. If only a portion of the subscriber account balance is reserved, an available balance still remains and may be otherwise used.

Reverse rating may be performed more than once for a particular service request, as is sometimes the case with session-based services. Unlike an event-based service, the full cost of a session-based service is not known until the session is complete. Then the duration of the session or quantity of the service or quality of the service (QoS—which may be changed during the session) used, or some similar measure, is converted into the monetary amount that is deducted from the subscriber account balance during normal rating. If more than one reverse rating is used for a session-based service, then normal rating may be but is not necessarily done more than once as well.

Reverse rating is important because it helps to ensure that service providers receive payment for the services they render through the communication network. It does, however, consume computer processing resources. In the aggregate, the amount of processing capacity devoted to reverse rating is not insignificant. To address this issue, the present invention includes a system and method for selective reverse rating. In embodiments of the present invention, reverse rating is not performed for all service requests. The process of the present invention will now be described in greater detail.

FIG. 2 is a flow diagram illustrating a method 200 of billing according to an embodiment of the present invention. At START, it is presumed that the necessary components are available and operational according to this embodiment. The process then begins with the receipt of a service request (step 205). The service request typically though not necessarily originates from a UE, for which the service, for example in the form of a content download or a telephone call, will be provided. The request may then be relayed or represented by another message generated in the access network.

In this embodiment, the service request is received at a service element, for example service element 120 shown in FIG. 1, which includes a charging client. According to some established protocols, this client is referred to as a CTF, and that terminology will be used in relation to this embodiment. In other embodiments, the charging client may be differently referred to or located within a different network element.

In this embodiment, when the CTF receives the service request at step 205, it generates a charging request and transmits it to the OCS (step 210), for example OCS 130 shown in FIG. 1. In the embodiment of FIG. 2, when the OCS receives the charging request, it determines the call type (step 215). Here, the OCS determines the service that is being requested. For example, a voice call may be domestic or international, or the subscriber may be roaming internationally. A text message could be an ordinary SMS message or premium SMS. The request for service could be a one-time event such as a content download or a session-based event such as a voice call.

In the embodiment of FIG. 2, the OCS then determines the payment method associated with the charging request (step 220). For example, the requested service may be partly or completely available on credit (post-paid). For a single subscriber, some services may be available under this arrangement while others must be pre-paid. Emergency calls, for example, to a 911-type of number may always available on a post-paid basis, or perhaps not charged for at all. The subscriber account balance is then determined (step 225). The amounts are preferably stored in an OCS database or readily accessible to the OCS.

Note that the above-described steps 215 through 225 may be performed in any sequential order, and in practice may be performed at the same or almost the same time. In other embodiments, one or more of these steps may not be performed at all. In other embodiments, addition determinations may be made may be made as well. These determinations may be made in a number of ways. In some implementations some or all of the information required may be transmitted in the charging request itself. In some implementations, the OCS will have to query its own database or seek the information from another component where the information is stored. Finally, note that even in some implementations where each of these determinations may be made, they may be omitted in some circumstance, for example where the determination of step 230 may be made based on less than all of the information otherwise available.

In the embodiment of FIG. 2, the OCS makes a determination of whether reverse rating is to be performed (step 230). In accordance with this embodiment, the determination of step 235 is made by comparing the charging request with reverse rating policy rules, which are preferably maintained in an OCS database or in another location that is readily accessible. For example, the OCS may determine that reverse rating is not necessary for domestic phone calls, but is for international calls. This determination may be dependent on the identity of the subscriber, for example a customer of long-standing may be flagged as not requiring reverse rating for certain types of calls. The subscriber account balance may also be taken into consideration together with the type of services being requested. Domestic-call or low-tariff downloads may not require reverse rating if the subscriber has a high pre-paid balance or credit limit. Of course, if the particular service requested, or the particular subscriber, does not require pre-payment, reverse rating need not be performed.

In an alternate embodiment (not shown) the determination of whether reverse rating is to be performed is made after each of the determination steps 215 through 225, comparing the information associated with the service request to the relevant policy rules. As alluded to above, some factors may be determinative of reverse-rating necessity, and when such a factor is encountered there is no need to consider others. The order in which the determinations of steps 215 through 225 are performed may of course be influenced by the presence of factors that are determinative in and of themselves.

According to the embodiment of FIG. 2, if the OCS determines at step 230 that reverse rating is to be performed, then the reverse rating process is initiated (step 240). The reverse rating process, as mentioned above, includes reserving or deducting a portion (or all) of the subscribe account balance. This necessarily includes determining whether the subscriber account balance is large enough to permit the requested service. If not, the charging request and the service request are declined. Typically, a notification will be transmitted to the UE to this effect, although this is not required in all cases. Reverse rating in this embodiment includes determining the number of non-monetary units needed for this particular service request and calculating an associated monetary amount. This amount is then reserved or deducted from the subscriber account balance. A quota representing a certain amount of the service, usually in non-monetary units, is then sent to the CTF (step 245) and performance of the service is permitted within the quota contained in the charging response.

For some implementations, the reverse rating process is specified by standard, for example in 3GPP TS 32.251, TS 32.299 or IETF RFC 4006. If, in accordance with the present invention, it is determined that reverse rating is to be performed, in most embodiments it is expected to be performed in accordance with the applicable current standards, although deviations may occur in some implementations.

If, on the other hand, the OCS determines at step 230 that reverse rating is not to be performed, in this embodiment the charging response is sent (step 245) and performance of the requested service is permitted. Here it is presumed that a determination not to perform reverse rating implies that there is no reason to consider declining the service for some reason. If in an alternate embodiment a separate determination should be considered desirable, then of course it may be performed, with or without a notification to the user that the service request has been denied. (This may occur, for example, when the subscriber has requested that that no content downloads be permitted through this particular account.)

In a preferred embodiment, if reverse rating is not to be performed, then the OCS assigns a dummy quota (step 235) and transmits it to the CTF (at step 245) in the charging response message. This will permit the CTF to allow the service where it must receive some quota to do so. It may also be used to ensure that unlimited service usage is not permitted, for example where a subscriber finishes a call but inadvertently fails to successfully terminate it. In any event, the dummy quota amounts are preferably set in accordance with the policy rules established for the practice of the present invention.

In the embodiment of FIG. 2, if for any reason provision of the requested service must be declined, then the charging response of step 245 will contain an indication of this, and the requested call, message, download, or other service will not be performed. Otherwise, performance of the requested service may commence (step 250). As the service is being performed, the CTF monitors the performance (step 255) to make sure that the service quota or the dummy quota, as applicable, has not been exceeded. If it has not, provision of the service will simply continue until it is completed.

In this embodiment, if the applicable quota has been exceeded, then the process returns to step 210, with the sending of a charging request to the OCS. Note that this will most likely occur in situations where reverse rating has been performed, as in many but not all currently-expected implementations the dummy quota will be set sufficiently high so as to avoid returning to step 210. In some embodiments, the new charging request may for this reason indicate that it is a dummy quota that has been exceeded. As should be apparent, however, if a new control message is sent, performance of the service will either be halted or allowed to continue.

Here it is noted that returning to step 210 is expected to occur rarely if ever in the case of event-based services, as the quota is typically set high enough to allow completion of any service whose cost can be ascertained in advance. Note also that in some embodiments, the return to step 210, if any, may be done when a certain threshold below the quota as been reached.

In the embodiment of FIG. 2, when the service has been completed (step 260) because it is finished, terminated by the user, or terminated by the CTF, the CTF transmits a charging request debit (not separately shown) to the OCS, where normal rating is executed (step 265). As mentioned above, normal rating may include converting the service usage reported by the CTF into monetary units and deducting this amount from the subscriber's account balance (or otherwise reconciling the account). Note that in some embodiments, normal rating may be done each time a quota has been reached even if the service has not been completed. Again, it is expected that in many though not necessarily all implementations, normal rating will be executed according to applicable current standards.

Note that the sequence in FIG. 2 is an illustration of one embodiment of the present invention, and some variation may occur in other embodiments; the individual operations of the method 200 may be performed in any logically-consistent order. In some embodiments, additional operations added, and in some cases removed, without departing from the spirit of the invention.

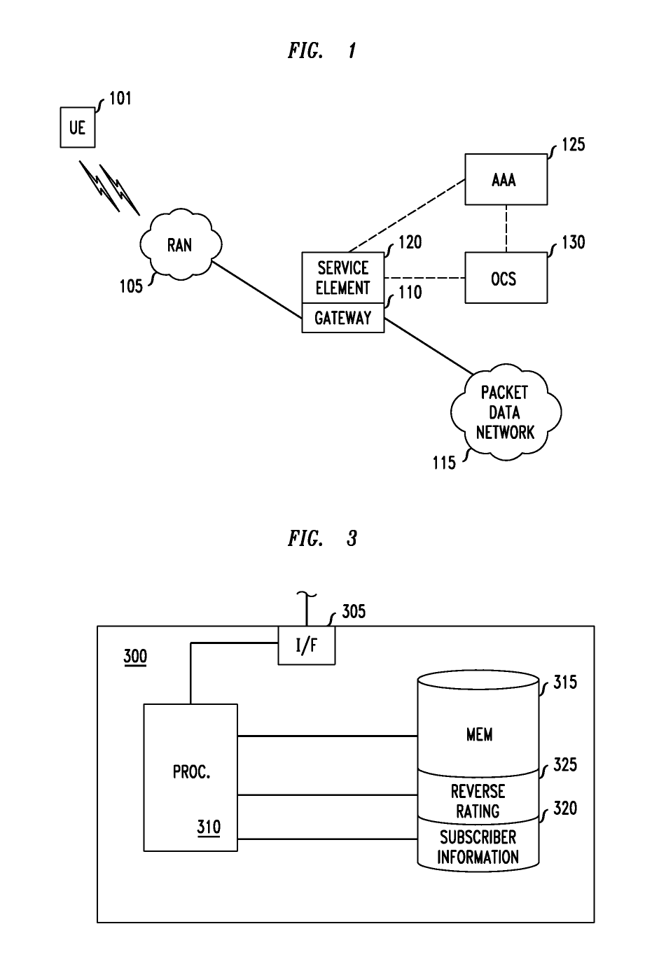

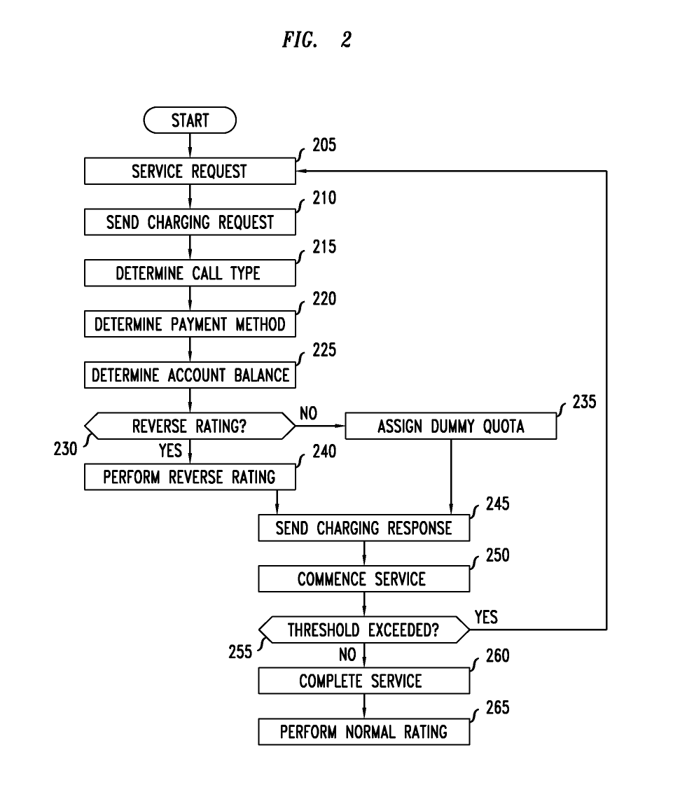

FIG. 3 is a simplified block diagram illustrating selected components of an OCS 300 according to an embodiment of the present invention. OCS 300 includes a network interface 305 for communicating with other network components such as a CTF or other service element. Also present is a processor 310 for controlling the components of OCS 300 and performing the process of the present invention according to instructions stored in a memory device within or accessible to OCS 300. Memory device 315 is present in the OCS 300 in this embodiment. Illustrated separately is a subscriber information module 320, where subscriber information such as subscriber accounts balances may be store. A reverse rating determination module 325 is present and also depicted separately, and its operation according on one embodiment is described above. This and the other functions of the present inventions are implemented in hardware or software stored in (non-transitory) storage media, or both.

Note, however, that in other implementations, each of these functions may be present in the same or different physical components or storage media. For example, one implementation of the present invention in an LTE network will now be explained in more detail.

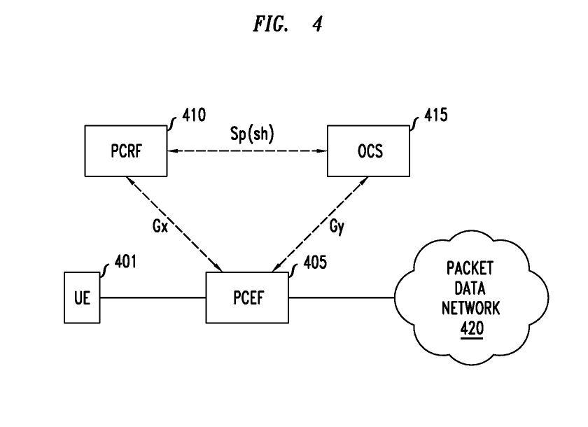

FIG. 4 is a simplified schematic diagram illustrating selected components of an LTE network configured according to the present invention. The illustrated components are PCEF 405, PCRF 410, and OCS 415. Here again it is noted that the function of an OCS according to the LTE protocols is one example of an OCS as that term is used herein. In the LTE environment, the interfaces between each of these devices are identified with a particular designator, and these designations are also shown in FIG. 4. Control signal paths are represented by broken lines, while the data plane connecting UE 401 to PDN 420 is depicted as a solid line.

In this embodiment, UE 401 typically accesses the network via a wireless interface to an access network similar to the one illustrated in FIG. 1. The PCEF 405 acts as a gateway to PDN 420. OCS 415 stores subscriber profiles including account balance information as well as tariff information relating to the provision of services. OCS 415 performs normal rating to deduct service charges from the subscriber account balance when a service has been performed, and also performs reverse rating if it is to be performed for a particular service request from UE 401.

The determination of whether reverse rating is to be performed is made by PCRF 410, which queries the OCS 415 to obtain the account balance, tariff, and any other information stored there that is needed to make the determination, via a Diameter Sp/Sh interface (as shown in FIG. 4) or any other APIs/Reference Points. The PCRF then installs the rules that will be used for charging, including whether reverse rating is to be performed.

In the embodiment of FIG. 4, PCEF 405 supports both the one-stage and the two-stage charging models. In the one-stage, or “direct debit” model, PCEF 405 does not send a charging request to reserve any portion of the subscribe account balance. When PCRF 410 indicates that a one-stage model is to be used for a particular service request, PCEF 405 simply sends a request to OCS 415 to perform normal billing against the subscriber account. As should be apparent, this charging model is useful for event-based services where the total charge can be ascertained in advance, though there is no requirement in the present invention that it be used in all such cases. Such a requirement may be imposed by standard, of course, or indicated in the policy rules stored at PCRF 410.

In accordance with this embodiment of the present invention, one-stage charging may also be employed if the PCRF 410 determines that reverse rating is not to be performed. Even in the case of session-based services, when one-stage charging is indicated a charging request may be sent to the OCS 415 after the service has been completed and the units of the service consumed can be ascertained. In some cases, the PCRF may also impose a dummy quota by indicating that new rules must be obtained from the PCRF 410 when the quota or some other threshold has been reached. In a preferred embodiment, PCEF 405 is also operable to switch between one-stage charging and two-stage charging when indicated by the charging rules.

If the PCRF 410 determined that reverse rating is to be performed, it will of course indicate that the two-stage model is to be used. In this case, PCEF 405 will send a charging request to the OCS 415, indicating that reverse rating is to be performed. An appropriate reservation or deduction will be made against the subscriber account balance. When performance of the requested service has been completed, a charging request is sent so that normal rating may be performed. Of course, if indicted in the charging rules installed on PCEF 405, intermediate charging requests may be sent to OCS 415 as well. In some embodiments, a preliminary charging request may be sent from PCEF 405 to OCS 415 to indicate that the service is to be provided but reverse rating is not to be performed. In these embodiments, a dummy quota may be returned from OCS 415 to PCEF 405 in response.

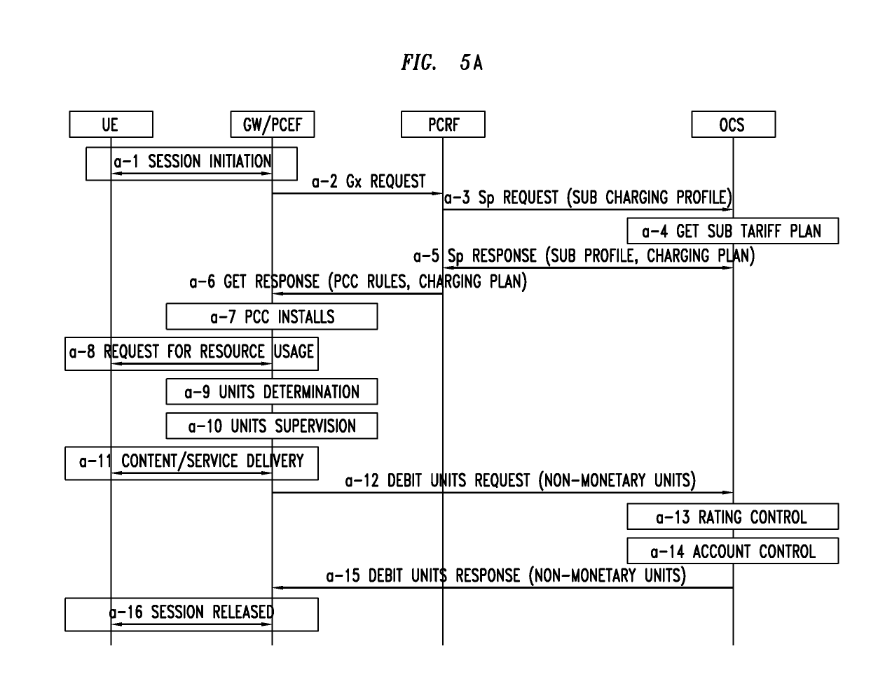

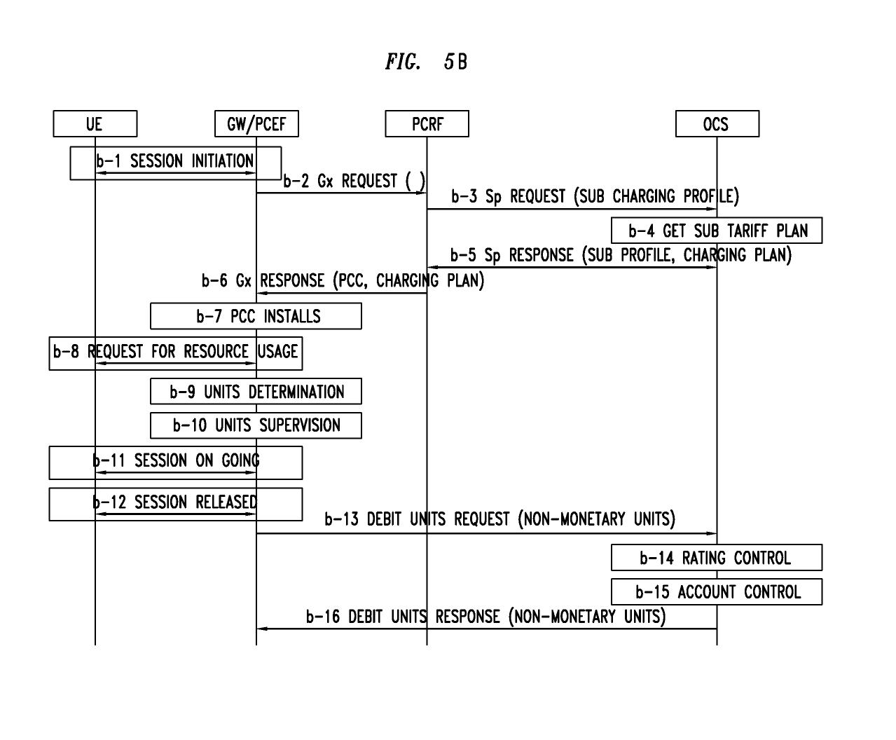

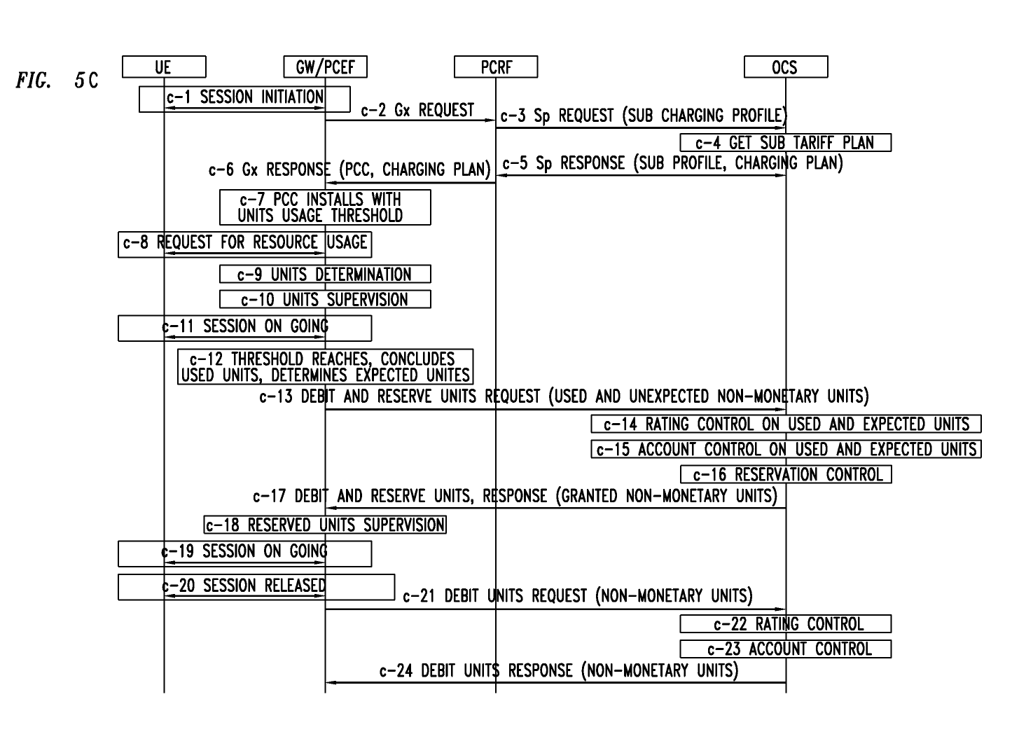

Operation of the billing methods of the present invention may be illustrated by exemplary message flows in reference to FIGS. 5a through 5c. FIG. 5a is a message flow diagram illustrating a process according to the present invention for event-based charging in an LTE or similar environment, for example as implemented in the components depicted in FIG. 4. The process of FIG. 5a begins when a service or session request from a UE, is received in a PCEF (a-1). The PCEF then send a request using the Gx interface to a PCRF (a-2) for the charging rules that will apply to the anticipated provision of the service. The PCRF, in turn, sends a request to an OCS using the Sp(Sh) interface (a-3) to retrieve the tariff plan associated with the requested service and profile information for the subscriber associated with the UE that sent the service request. The OCS determines this information (a-4) and returns it to the PCRF via the Sp interface (a-5). Note that the interfaces used in this embodiment; in other embodiments, foe example, instead of the Sp (or Sp(Sh)) interface, TCP/IP, SOAP/XML, LDAP, or others may be used.

In this embodiment, the PCRF then determines, based in the policy rules for the network and the information it has received, whether reverse rating is to be performed. If so, reverse rating is initiated, typically following the existing standard (not shown). In the embodiment of FIG. 5a, it is presumed that the determination has been made not to perform reverse rating, therefore the PCRF will return the PCC rules to the PCEF via a Gx response (a-6). The PCEF installs these rules (a-7), and sends an acknowledgement to the UE (a-8), indicting that that the service request has been granted.

In this embodiment, the PCEF then performs a unit determination for the service request (a-9), and then monitors the data connection accordingly (a-10). The event-based service, such as a content download or text message transmission, is performed (a-11). Note that here it is presumed that the unit determination is not exceeded, which can typically be expected for an event-based service.

In the embodiment of FIG. 5a, once the service as been executed, the PCEF sends a message to the OCS (a-12), indicating the units of service that have been delivered. The message may be referred to as a “direct debit unit request” and usually is expressed in non-monetary terms. The OCS can then perform normal rating, calculating the monetary charge for the service (a-13) and deducting this amount from the subscriber account balance (a-14). The OCS then returns an acknowledgement, which may be referred to as “debit unit response” to the PCEF (a-15). The PCEF then releases the data session (a-16).

FIG. 5b is a message flow diagram illustrating a process according to the present invention for session-based charging in an LTE or similar environment (reference can again be made to FIG. 4). Similar to the process of FIG. 5a, the process of FIG. 5b begins when a session request from a UE, is received in a PCEF (b-1). The PCEF then send a request using the Gx interface to a PCRF (b-2) for the charging rules that will apply to the anticipated provision of the service. The PCRF, in turn, sends a request to an OCS using the Sp(Sh) interface (b-3) to retrieve the tariff plan associated with the requested service and profile information for the subscriber associated with the UE that sent the service request. The OCS determines this information (b-4) and returns it to the PCRF via the Sp interface (b-5).

In this embodiment, the PCRF then determines, based in the policy rules for the network and the information it has received, whether reverse rating is to be performed. If so, reverse rating is initiated, typically following the then standard procedure (not shown). In the embodiment of FIG. 5b, it is presumed that the determination has been made not to perform reverse rating, therefore the PCRF will return the PCC rules to the PCEF via a Gx interface response (b. The PCEF installs these PCC rules (b-7), and sends an acknowledgement to the UE (b-8), indicting that that the service request has been granted.

In this embodiment, the PCEF then performs a unit determination for the service request (b-9), and then monitors the communication session accordingly (b-10). The session-based service, such as a voice call, then takes place (b-11). In this exemplary embodiment, it is presumed that the unit determination is not exceeded and the session continues until (in most cases) it is terminated by the UE (b-12).

In the embodiment of FIG. 5b, once the session has been terminated, the PCEF sends a direct debit request to the OCS (b-13), indicating the units of service that have been delivered. Again, this is usually is expressed in non-monetary terms. The OCS can then perform normal rating, calculating the monetary charge for the service (b-14) and deducting this amount from the subscriber account balance (b-15). The OCS then returns a debit unit response to the PCEF (b-16).

In the exemplary embodiments above, it was presumed that a determination according to the present invention that reverse rating was not to be performed. This will not be the case for every service request, of course, and if a contrary determination is made then reverse rating will typically be performed. In either case, the service request may also be declined, for example due to an insufficient subscriber account balance. In some cases, however, when a determination is made that reverse rating is not to be performed, there may be a reason to switch instead to the standard reverse rating procedure. An example of such a case is shown in FIG. 5c.

FIG. 5c is a message flow diagram illustrating a process according to the present invention for session-based charging in an LTE or similar environment (reference can again be made to FIG. 4). Similar to the process of FIGS. 5a and 5b, the process of FIG. 5c begins when a session request from a UE, is received in a PCEF (c-1). The PCEF then send a request using the Gx interface to a PCRF (c-2) for the charging rules that will apply to the anticipated provision of the service. The PCRF, in turn, sends a request to an OCS using the Sp(Sh) interface (c-3) to retrieve the tariff plan associated with the requested service and profile information for the subscriber associated with the UE that sent the service request. The OCS determines this information (c-4) and returns it to the PCRF via the Sp interface (c-5).

In this embodiment, the PCRF then determines, based in the policy rules for the network and the information it has received, whether reverse rating is to be performed. If so, reverse rating is initiated, typically following the then-existing standard procedure (not shown). In the embodiment of FIG. 5c, it is presumed that the determination has been made not to perform reverse rating, therefore the PCRF will return the PCC rules to the PCEF via a Gx interface response (c-6). In this embodiment, the PCEF installs these PCC rules (c-7) and includes a unit threshold. The unit threshold is a limit established for the use of the service without the need to perform reverse rating. The PCEF then sends an acknowledgement to the UE (c-8), indicting that that the service request has been granted.

In this embodiment, the PCEF then performs a unit determination for the service request (c-9), and then monitors the communication session accordingly (c-10). The session-based service, such as a voice call, then takes place (c-11). In this exemplary embodiment, it is at some point while the session is in progress that the unit threshold has been reached (c-12).

In the embodiment of FIG. 5c, when this occurs, the PCEF sends a direct debit request to the OCS (c-13), indicating the units of service that have been delivered. Again, this is usually is expressed in non-monetary terms. The message, which may be a CCR[initiate] message according to LTE standards and referred to as a “direct debit and Unit Request”, indicates to the OCS that reverse rating should now be performed with regard to the remainder of the session. Since some service has already been provided, the OCS performs both normal rating and reverse rating, first calculating the cost of the services performed in monetary terms and also determining an amount of the subscriber account balance to reserve for the subsequent potion of the session (c-14).

In this embodiment, the OCS then performs account control, and deducts from the subscriber account balance the calculated monetary amount for services already used (c-15). It also performs the reservation operation to reserve the determined account balance amount for the subsequent portion of the session (c-16). The OCS then sends a message to the PCEF indicating the amount of the service that has been reserved (c-17), typically in non-monetary terms. The PCEF then monitors (c-18) the ongoing session, which continues (c-19) until termination, most frequently because the UE terminates the session (c-20). When the session terminates, the PCEF sends message to the OCS (c-21) indicating the amount of service actually used, usually in non-monetary terms. In some implementations this may be a CCR[terminal] message and may be referred to as a “debit unit request”.

In the embodiment of FIG. 5c, the OCS then performs normal rating with respect to this potion of the session, beginning with calculating the cost in monetary terms of the service performed (c-22), and then performing the account control, deducting this monetary amount from the subscriber balance (c-23). The OCS then returns a debit unit response to the PCEF (c-24).

The exemplary scenarios described above are of course intended to be exemplary and not limiting. Other embodiments of the present invention may be implemented as well, and still remain in the spirit of the invention.

In this manner the present invention provides for a more efficient use of available processing resources and, over time, may enable saving in capital and operating expenses for the operator of the communications network by reducing the amount of hardware necessary to perform the accounting functions of the network.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for billing in a communication system, comprising:
receiving a service request associated with a UE device;
determining information relating to the subscriber associated with the UE;
comparing the service request with a policy rules database;
determining whether reverse rating is to be performed based on the comparison; and
performing reverse rating if it is determined that reverse rating is to be performed.

2. The method of claim 1, further comprising determining whether the service request should be granted.

3. The method of claim 2, further comprising acknowledging the service request.

4. The method of claim 1, further comprising assigning a dummy service unit quota if it is determined that reverse rating is not to be performed.

5. The method of claim 1, wherein reverse rating comprises determining a service unit quota based on a subscriber account balance.

6. The method of claim 5, further comprising deducting a monetary amount corresponding to the service unit quota from the subscriber account balance.

7. The method of claim 1, wherein the service request indicates a type of call and the determination of whether reverse rating is to be performed is a function of the call type indicated in the service request.

8. The method of claim 1, wherein the subscriber information comprises a subscriber account balance, and wherein the determination of whether reverse rating is to be performed is a function of the subscriber account balance.

9. The method of claim 1, wherein the determination of whether reverse rating is to be performed is a function of the payment type associated with the service request.

10. The method of claim 1, further comprising performing normal rating.

11. The method of claim 10, wherein the normal rating is performed after the communication session associated with the service request has been terminated.

12. The method of claim 1, further comprising determining whether reverse rating should be performed after a communication session associated with the service request has commenced.

13. The method of claim 1, wherein the determination of whether reverse rating is to be done is performed by an OCS in a network operating according to a Diameter protocol.

14. The method of claim 1, wherein the determination of whether reverse rating is to be done is performed by a PCRF in a network operating according to an LTE protocol.

15. An online charging system for use with a communication system, comprising:
a memory device comprising non-transitory storage media; and
a processor for executing software stored on the non-transitory storage media for:
retrieving stored subscriber information relating to a request for service;
determining whether reverse rating is to be performed with respect to the request for service based at least in part on comparing policy rules stored in the memory device with the retrieved subscriber information; and
performing reverse rating if it is determined that reverse rating is to be performed.

16. A charging system for use in an LTE communication network, comprising:
an OCS configured for maintaining information relating to subscribers comprising subscriber account balance information;
a PCRF configured for determining whether reverse rating should be performed with regard to a request for service, wherein the determination is a function of subscriber information retrieved from the OCS by the PCRF; and
a PCEF configured for receiving the request for service and communicating with the PCRF to initiate the determination and for enforcing rules provided to the PCEF by the PCRF relating to the performance of the service requested in the request for service.
